(19) United States
(12) Patent Application Publication
(10) Pub. No.: US 2013/0111987 A1
(43) Pub. Date: May 9, 2013

(54) LEVEL DETECTION DEVICE IN A CASTING EQUIPMENT AND RELATIVE DETECTION METHOD

(71) Applicant: Lorenzo Ciani, Udine (IT)

(72) Inventor: Lorenzo Ciani, Udine (IT)

(73) Assignee: DANIELI AUTOMATION SPA, Buttrio (IT)

(21) Appl. No.: 13/809,824

(22) PCT Filed: Jul. 13, 2011
(86) PCT No.: PCT/IB11/01632

§ 371 Date: Jan. 11, 2013

(30) Foreign Application Priority Data
Jul. 14, 2010 (IT) UD2010A 000139

(51) Int. Cl. G01F 23/284

(52) U.S. Cl. 73/290 R

(57) ABSTRACT

A level detection device in casting equipment oscillating linearly, in a manner concordant with a substantially vertical direction of advance of molten steel in the casting equipment at a desired frequency of oscillation includes the device oscillating at the same frequency and disposed at a predetermined operating height. The device generates a continuous magnetic field, and the field generator is oriented transversely to the direction of advance of the steel in the casting equipment, so as to generate alternate induced currents in the molten steel. The device detects a variable induced magnetic field generated by and concatenated with said alternate induced currents, wherein the intensity of the variable induced magnetic field as detected is correlated to the level of the molten steel in the casting equipment with respect to the operating height.

### FIELD OF THE INVENTION

The present invention concerns a device for detecting the level in a continuous casting equipment and the relative detection method.

In particular, the device and method according to the present invention allow to detect the level of the liquid steel, that is, the meniscus, in an ingot mold for the continuous casting of steel products, such as billets, blooms or slabs.

A device having the characteristics of the preamble of the main claims is described in EP-A1-0060800 (and in the corresponding U.S. Pat. No. 4,441,541).

### BACKGROUND OF THE INVENTION

Devices are known for detecting the level in casting equipment for the production of steel products, such as billets, blooms or slabs. These known devices are associated with a casting ingot mold and allow to detect the level of liquid steel present therein, so as to keep it at a predetermined value and to feed in its turn, in a constant manner and at a desired casting speed, a rolling line located downstream Of the ingot mold.

Known detection devices comprise a radiation emitter, typically an emitter with radioactive isotopes and a corresponding radiation detector, sensitive to the specific type of isotopes. The emitter and the radiation detector are operationally disposed outside the crystallizer, on opposite walls thereof and at a predetermined operating height, corresponding to a desired and predetermined level of liquid steel to be maintained.

The intensity of radiation detected depends on the actual absorption of the radiations emitted in their passage through the crystallizer and the liquid steel. Indeed, the presence or absence of liquid steel in the crystallizer in correspondence with the operating height determines a greater or lesser absorption of the radiations emitted.

One disadvantage of these known devices is that, although they have a reasonable detection speed which allows a desired control of the casting of the steel, they do not have great precision. Indeed, known devices do not allow to discriminate the actual level of the meniscus with respect to an overlying layer of protective and lubricating powders, which is normally put to cover it in order to prevent the surface oxidation of the steel.

Therefore, known devices detect a level in the ingot mold which also includes the thickness of the layer of powders, thus distorting the measurement and causing possible problems in the management of the casting process.

Furthermore, using radiation emitters, known devices can be rather dangerous for the health of the workers and have high costs of production and maintenance.

In addition, since the casting equipment, that is, the crystallizer, is normally associated with an oscillating bench that is made to oscillate vertically at a predetermined frequency of oscillation so as to promote the advance of the solidified steel, known devices are stably associated with the casting equipment itself. Therefore, known devices require frequent diagnostic and maintenance controls, and also a rather complicated initial set up of the radiation emitter and detector, which causes an increase in the operating costs of the casting equipment.

Devices for detecting the level of the molten metal in a crystallizer are also known which comprise emitters of pulsating magnetic fields, generated by electromagnets and mating detectors of the field induced determined by the currents that form in the metal contained in the crystallizer.

Such devices, like the one described in EP'800 as above, do not guarantee adequate precision and sensitivity due to the interferences and disturbances on the detectors caused by the magnetic field induced.

One purpose of the present invention is to achieve a device for detecting the level in a continuous casting equipment, in particular in an ingot mold, which allows to detect with precision and great sensitivity the actual level of steel even when there is a layer of covering powders present.

Another purpose of the present invention is to achieve a device for detecting the level in a continuous casting equipment, in particular in an ingot mold, which allows to reduce the relative times and costs for setting up and operating.

Another purpose of the present invention is to achieve a device for detecting the level in a continuous casting equipment, in particular in an ingot mold, which has a sufficiently rapid detection time so as to allow to regulate the level even in high speed casting lines.

Another purpose is to perfect a method for detecting the level in a continuous casting equipment, in particular in an ingot mold, which allows to detect, precisely and quickly, the actual level of the steel in the casting equipment.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, a level detection device according to the present invention is stably associated with a continuous casting equipment, such as a ingot mold, which oscillates linearly in a manner concordant with a substantially vertical direction of advance of the steel in the ingot mold, at a desired frequency of oscillation. The device according to the present invention is solid with the casting equipment so as to oscillate at the same frequency of oscillation and is disposed at a predetermined operating height, corresponding to the level or levels of molten steel to be detected.

According to one feature of the present invention, the device comprises or is associated with magnetic field generating means, configured to emit a substantially continuous magnetic field, oriented transversely to the direction of advance of the steel in the ingot mold, so as to generate, due to the effect of the oscillatory motion, alternate induced currents in the advancing molten steel.

The device also comprises means to detect the magnetic field, configured to detect a variable induced magnetic field generated by and concatenated with the alternate induced currents. The intensity of the variable magnetic field, as detected by the detection means, is correlated to the actual level of molten steel in the casting equipment with respect to the operating height of the device.

The lines of the continuous magnetic field generated by the generating means develop substantially parallel to, and mainly outside, the position of the detection means so that the detection means are not passed through, or are passed through only minimally, by the lines of the continuous magnetic field.

According to a preferential characteristic of the present invention, the magnetic field generating means consist of at least two magnets, oriented toward the wall of the ingot mold with the same polarity, in the middle of which the detection means are disposed, advantageously consisting of an array of detector elements disposed vertically parallel to each other.

This configuration optimizes the characteristics of sensitivity and precision of the device. Indeed, thanks to the disposition of the magnets at the sides of the detectors, with identical polarities oriented toward the wall of the crystallizer, the lines of the continuous magnetic field generated by the magnets are closed mainly outside the group of magnets, between one pole and the opposite pole of the same magnet, and not between the two magnets as would happen if the magnetic poles oriented toward the wall of the crystallizer were opposite.

In this way, the component of the lines of magnetic field which hit and pass through the detectors is minimized, thus allowing to increase their sensitivity and precision.

Furthermore, the presence of little detectors disposed according to a vertical arrangement astride the nominal meniscus of the liquid metal allows to detect the growing development of the signal obtained by the successive detectors due to the effect of the liquid metal, and hence of the currents inside the liquid metal, thus optimizing the efficiency of the detector.

Therefore, the level detection device according to the present invention allows to detect with greater precision the actual level of the molten steel in the casting equipment, since the continuous magnetic field produced by the generating means, also passing through the possible layer of protective and lubricating powders above the meniscus of the molten steel, due to the effect of the extremely low electric conductivity of the powders, does not generate components of induced currents in the layer of powders, allowing to detect only the variable magnetic field produced by the induced currents circulating in the molten steel.

According to a variant of the present invention, the detection means comprise a plurality of magnetic field detector elements, disposed in a direction substantially parallel to the direction of advance and distanced one from the other so as to define a detection range of the level of molten steel. Therefore, each detector element detects a different value of intensity of the magnetic field induced, which is correlated to the actual level of the molten steel in the casting equipment with respect to the position of the specific detector element. Detector elements disposed above the meniscus of the molten steel detect gradually decreasing intensities of the magnetic field induced, depending on their distance from the meniscus itself, while detector elements that are found far below the meniscus detect maximum intensity of the magnetic field induced.

A variant of the invention provides that the magnetic field generating means comprise at least two continuous magnetic field generating elements positioned in an opposite manner with respect to the casting equipment and able to cooperate reciprocally to increase the intensity of the continuous magnetic field inside the casting equipment, for example the ingot mold. Therefore, the presence for example of two permanent magnets allows to increase the intensity of the magnetic field induced and to concentrate its development inside the casting equipment, for example in an ingot mold of the type with plates for casting thin slabs, which in its turn improves the intensity of the magnetic field induced and hence the detection of the level of steel.

According to another variant, the detection device according to the present invention comprises processing means connected to the detector elements so as to acquire corresponding electric signals relating to the induced field detected. The processing means are configured to process and estimate the amplitude of the electric signals in a prediction time at least shorter than the period of the frequency of oscillation. Therefore, the level detection device according to the invention has a detection speed at least equal to that of state-or-the-art devices, allowing to regulate the feed rate of the molten steel to the casting equipment and to maintain the level at the desired value.

According to a variant of the present invention, the processing means comprise a Kalman prediction filter.

According to another variant of the present invention, the device comprises movement detection means, connected to the processing means and able to detect the frequency and phase of oscillation of the casting equipment. Therefore, the movement detection means allow to render the detection speed higher, that is, to effect a prediction more quickly.

The present invention also concerns a method to detect the level in a continuous casting equipment, in particular an ingot mold, oscillating linearly in concordance with a direction of advance of the steel in the ingot mold, at a desired frequency of oscillation.

According to one feature of the invention, the method comprises an emission step in which, by means of magnetic field generating means, disposed at a predetermined operating height, a substantially continuous magnetic field is generated, with flow lines oriented transversely to the direction of advance of the steel in the ingot mold and the oscillatory motion of the mold, so as to generate alternate induced currents in the advancing molten steel.

The method also comprises a detection step in which, by means of magnetic field detection means, a variable magnetic field is detected, generated by and concatenated with said alternate induced currents. The intensity of the variable magnetic field is correlated to the actual level of the molten steel in the casting equipment.

According to a variant of the present invention, during the detection step the induced magnetic field is detected at a plurality of points along the casting equipment. These points are disposed in a direction substantially parallel to the direction of advance and are distanced from each other so as to define a detection range of the level of molten steel.

According to another variant of the invention, the method also comprises a processing step in which, by means of processing means connected to the detection means, electric signals relating to the induced magnetic field as detected by the detection means are processed, and the amplitude of the electric signals is estimated in a prediction time at least less than the period of the frequency of oscillation.

According to another variant, the frequency and phase of oscillation of the casting equipment is detected by means of movement detection means.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a lateral schematic view, partly in section, of a device for detecting the level in a casting equipment according to the present invention;

FIG. 2 is a view in section from II to II in FIG. 1;

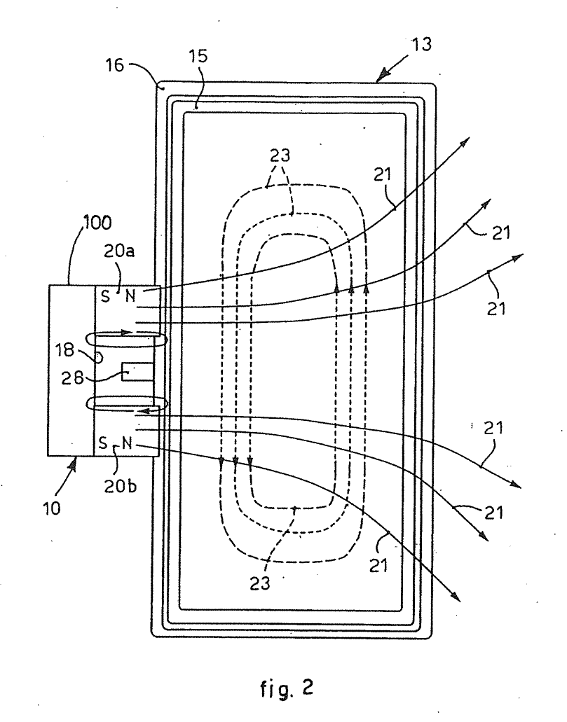

FIG. 3 is a view in section of a variant of the level detection device according to the present invention;

FIG. 4 is a perspective view of one form of embodiment of the device according to the present invention.

### DETAILED DESCRIPTION OF A PREFERENTIAL FORM OF EMBODIMENT

With reference to the attached drawings, a level detection device 10 according to the present invention is stably mounted on a continuous casting equipment, for example on an ingot mold 13, for the production of steel products. The device 10 is attached solid with a conveyor 16, at a predetermined operating height, so as to define a detection range “R”, in which the level of the meniscus 34 of the molten steel must be maintained, in order to guarantee the correct management of the casting line, not shown in the drawings.

The ingot mold 13 has the conveyor 16 and a crystallizer 15 in which the steel is cast and the first skin of the molten steel is formed. The ingot mold 13 is mounted on an oscillating bench, not shown, which determines the oscillation in a linear and alternate manner in two opposite directions, as indicated by the arrow “F”, of the ingot mold 13 and the device 10.

Oscillation occurs in a direction concordant with a vertical direction of advance “A” of the steel inside the crystallizer 15 and with a predetermined frequency of oscillation so as to promote the detachment of the steel from the walls of the crystallizer and the correct advance of the steel. In one form of embodiment, the oscillation has a frequency of about 2 Hz, corresponding to a period of about 0.5 s, and a linear amplitude of oscillation “peak-to-peak” of about 10 mm.

The device 10 comprises one or more permanent magnets, in this case (with reference to the drawings) two 20a on the right and two 20b on the left, and a plurality of magnetic field detectors 28, to detect a variable induced magnetic field, as will be described in more detail hereafter. The device 10 also comprises a processing unit 38 and an accelerometer 40.

The permanent magnets 20a and 20b are mounted adjacent to the conveyor 16, associated with a surface of its outer wall, possible embedded in a hollow seating made on the conveyor 16 so as to reduce the distance between the device 10 and the mass of steel in the ingot mold 13. It is understood that instead of the permanent magnets 20a and 20b any magnetic field generator can be used which produces a continuous magnetic field.

The permanent magnets 20a and 20b are contained in a container 100 having a vertical development and are disposed adjacent, defining an intermediate seating 18 between them in which the detectors 28 are housed. The permanent magnets 20a and 20b are disposed so as to generate a continuous magnetic field whose flow lines 21 are oriented transversely to the direction of advance of the steel. In particular, the flow lines 21 of the continuous magnetic field generated by the permanent magnets 20a and 20b are directed perpendicular to the internal walls of the crystallizer 15 and hence to the direction of advance of the molten steel. The flow lines 21 of the continuous magnetic field start from north poles, indicated by “N”, and close on respective south poles indicated by “S”. As can be seen in the drawings, both the magnets 20a and 20b have their respective north pole “N” oriented toward the wall of the ingot mold, so that the flow lines 21 close between the north pole and the south pole of the magnets 20a and 20b, and not between one magnet and the other. In this way, the flow lines 21 close mainly outside the detectors 28 and do not hit the detectors 28, or do so only in a minimal and negligible manner.

A part of the flow lines pass through the inner volume of the crystallizer and interact with the mass of liquid steel possibly inside it.

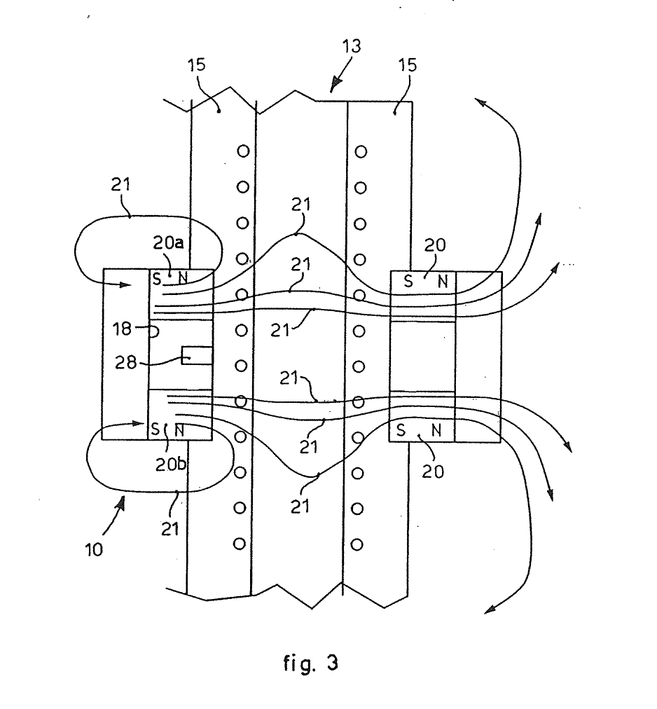

According to a variant shown in FIG. 3, the device 10 comprises two groups of permanent magnets, coupled, embedded in opposite walls of the ingot mold 13 so as to increase the intensity of the continuous magnetic field inside it. In particular, this form of embodiment is suitable for use in an ingot mold with plates, used in casting thin slabs. FIG. 3 also shows the development of the continuous magnetic field lines 21 inside the ingot mold 13. In this form of embodiment, the magnets 20 on the side where the detectors 28 are not present (in this case the right side), have a function of attracting the force lines of the continuous magnetic field generated by the magnets 20a, 20b disposed on the left side, forcing the magnetic field lines 21 to close respectively even more toward the outside, therefore without disturbing the detectors 28.

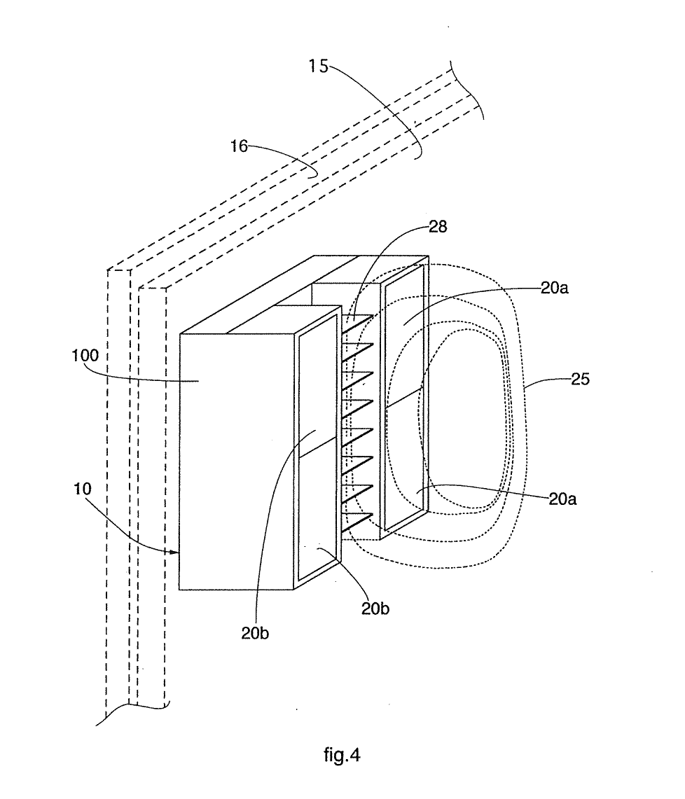

The detectors 28 are disposed in the housing seating 18, facing the external wall of the crystallizer 15, for example in the hollow seating, and are aligned vertically with respect to each other (as can be seen better in FIG. 4), in a direction substantially parallel to the direction of advance. As we said, the detectors 28 are disposed and oriented so that the continuous field produced by the permanent magnets 20, or by a component thereof, does not pass through them. In particular, the detectors 28 are disposed equidistant along the detection range R so that each one detects a specific intensity of the magnetic field induced; this intensity is correlated to the alternate induced currents generated in the liquid steel and therefore to the actual level in height of the steel in the ingot mold 13 inside the detection range R.

In one form of embodiment, the detectors 28 are Hall sensors. It is understood that any other type of sensor can be used, which is able to detect a variable magnetic field.

The detectors 28 are also connected, for example by means of an electric cable or a data communication cable, to the processing unit 38, so as to allow the data detected to be transferred and to allow a subsequent processing to estimate the level of the molten steel in the ingot mold 13, as will be described hereafter.

The processing unit 38 can be an industrial computer, a processing control unit such as a PLC or other similar device suitable for processing the data received from the detectors 28. The processing unit 38 can be provided for example with analog-digital converters to convert the electric signal detected by each detector 28 into digital data to allow to estimate the values of the induced magnetic field actually detected.

According to one form of embodiment the processing unit 38 comprises at least a predictive processing module, such as a Kalman filter, to accelerate the processing times of the signals arriving from the detectors 28.

The accelerometer 40, of a known type, is mounted on the ingot mold 13, solid with it, for example on an external wall or inside a container of the device 10 itself and is connected to the processing unit 38 by means of an electric cable or a data communication cable. The accelerometer 40 detects both the direction of movement of the ingot mold 13, upward or downward according to the specific oscillation semi-period, and also the frequency and phase of oscillation, and transmits them to the processing unit 38.

The level detection device 10 according to the present invention functions as follows.

To detect the level of the meniscus 34 of the molten steel in the ingot mold 13 a continuous magnetic field is emitted by the permanent magnet or magnets 20. The flow lines 21 of the continuous magnetic field pass perpendicularly through the copper walls of the crystallizer 15 and then hit the mass of molten steel according to a substantially rectilinear development, at least in a first segment near the crystallizer 15. Thanks to the configuration and disposition of the magnets 20a and 20b, and of the detectors 28, the magnetic field lines 21 close mainly on the outside of the respective magnets, and thus do not pass through the detectors 28.

The continuous magnetic field thus generated therefore oscillates vertically with respect to the mass of molten steel slowly advancing downward, which in turn generates induced alternate currents 23 inside the steel. As indicated by the line of dashes, the induced currents circulate substantially on a horizontal plane and have a frequency and phase closely correlated to that of the oscillation of the ingot mold 13.

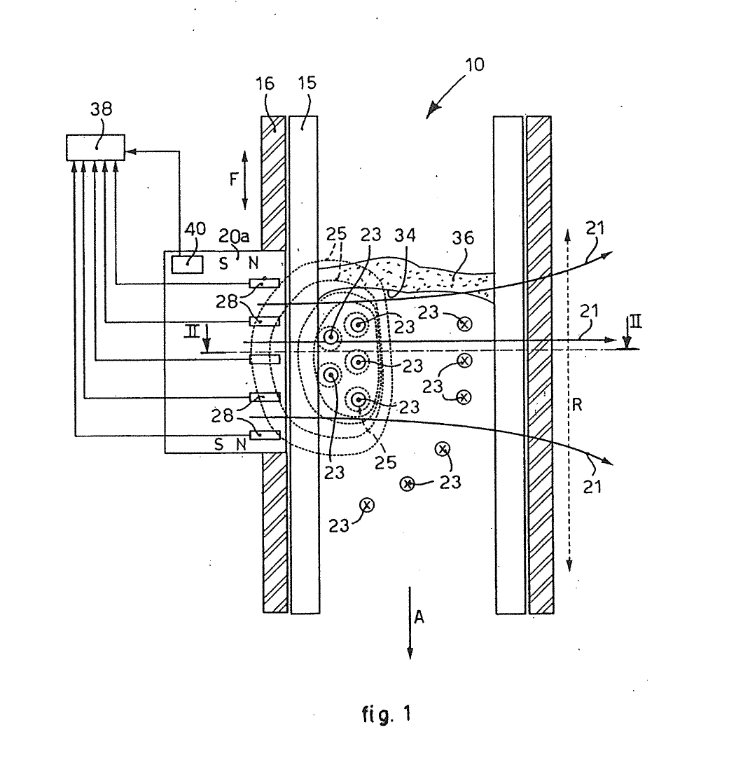

The induced alternate currents 23 in turn generate a variable magnetic field concatenated with them, and isofrequential with the oscillatory motion of the ingot mold 13. The induced magnetic field lines 25 thus generated (FIG. 1) in turn pass through the copper walls of the crystallizer 15 and are detected by the array of detectors 28. Since the frequency of variation of the induced currents is very low, the induced magnetic field passes easily through the walls of the crystallizer 15 so as to then be measured by the detectors 28.

The intensity of the induced magnetic field detected by each individual detector 28 largely depends on the induced alternate current circulating in the molten steel, and on the height at which the detector 28 is positioned with respect to the position of the meniscus 34. The intensity is minimal for detectors 28 positioned a long way above the level of the meniscus 34, and is maximal for detectors 28 positioned a long way below the level of the meniscus 34.

The processing unit 38 therefore processes the signals relating to all the detectors 28, indirectly finding the measurement of the actual level of the molten steel according to the specific intensity detected by each detector. The detection or measurement carried out is therefore very precise compared with state-of-the-art devices, since any layer of powder 36 disposed to cover the meniscus 34 is not actually detected, since no induced alternate current is circulating in it.

Furthermore, to guarantee a very short detection and response time, and hence to allow a prompt regulation of the level of molten steel in the ingot mold, a processing operation is carried out so as to detect the development of the induced magnetic field and hence of the induced electric currents. Indeed, the device 10 provides to effect, by means of the prediction module of the processing unit 38, a predictive estimate of the actual value of the amplitude of the variable induced magnetic field, in a processing time which is much shorter than the oscillation period of the ingot mold 13. The predictive estimate is also carried out using the signal of the accelerometer 40, which supplies the precise indication of the actual frequency and phase of the oscillation motion of the ingot mold 13.

In particular, the predictive processing module is configured to effect an estimate and then to supply a level detection in a detection time shorter than one fifth of the signal period, that is, the oscillation period.

In one form of embodiment, the detection time is about 100 ms. Therefore, the response time of the detection device according to the present invention is substantially comparable, or shorter than, the response time of state-of-the-art detection devices for example the type with radioactive isotopes.

Furthermore, compared with state-of-the-art detection devices, the device 10 according to the present invention allows to obtain more reliable detections and measurements of the level, since the detection of the variable induced magnetic field is less subject to noise and the penetration of the magnetic field, both continuous and variable, in the ingot mold 13 is not significantly affected by the overall typical thickness or the temperature of the walls of the ingot mold or by the molten steel.

It is understood that the permanent magnets can be replaced by elements that emit a magnetic field in the mass of steel. For example, it is possible to use a continuous magnetic field emitted by electromagnetic brakes associated with the ingot mold 13 in order to regulate the fluid motion of the steel.

1. Level detection device in casting equipment comprising:
at least a crystallizer oscillating linearly, in a manner concordant with a substantially vertical direction of advance of molten steel in the casting equipment and at a desired frequency of oscillation, said device being connected with said casting equipment so as to oscillate at the same frequency of oscillation and being disposed at a predetermined operating height, wherein a means to generate a continuous magnetic field is oriented transversely to the direction of advance of the steel in the casting equipment, so as to generate alternate induced currents in the steel, said means to generate a continuous magnetic field being associated with a wall of the crystallizer with a magnetic pole facing toward said wall, and a means to detect the magnetic field is disposed laterally facing said generating means and configured to detect a variable induced magnetic field generated by and concatenated with said alternate induced currents, wherein the field lines generated by said generating means develop substantially parallel to and outside the position of said detection means, and intensity of said variable induced magnetic field as detected by the detection means being correlated to the level of the steel in the casting equipment with respect to said operating height.

2. The device as in claim 1, wherein the magnetic field generating means consist of at least two magnets, laterally facing and oriented toward the wall of the crystallizer with the same magnetic pole, the detection means being disposed in an intermediate position between said magnets.

3. The device as in claim 1, wherein the detection means comprises a plurality of magnetic field detector elements, disposed in a direction substantially parallel to said direction of advance and distanced one from the other so as to define a detection range of the level of molten steel.

4. The device as in claim 1, wherein the magnetic field generating means comprise at least two magnetic field generation elements positioned on walls of the casting equipment and able to cooperate reciprocally in order to increase the intensity of the field lines.

5. The device as in claim 1, wherein comprising processing means connected to said magnetic field detection means, in order to acquire corresponding electric signals indicative of the induced field detected, said processing means being configured so as to process and estimate the amplitude of said electric signals in a prediction time at least less than a period of said frequency of oscillation.

6. The device as in claim 5, wherein said processing means comprises a Kalman predictive filter.

7. The device as in claim 5, comprising movement detection means, associated with said processing means, and able to detect the frequency and phase of the oscillation motion of the casting equipment.

8. A method to detect a level in casting equipment, which oscillates linearly, in a manner concordant with a direction of advance of molten steel in the casting equipment at a desired frequency of oscillation, the method comprising:
generating a continuous magnetic field oriented transversely to the direction of advance of the steel in the casting equipment, so as to generate alternate induced currents in the advancing molten steel; and
detecting a variable magnetic field, generated by and concatenated with said alternate induced currents, the intensity of the variable magnetic field being correlated to the level of the molten steel in the casting equipment with respect to an operating height at which magnetic field generating means and magnetic field detection means are positioned.

9. The method as in claim 8, wherein the magnetic field induced is detected at a plurality of points along the casting equipment, said detection points being disposed in a direction substantially parallel to said direction of advance and distanced one from the other so as to define a detection range (R) of the level of molten steel.

10. The method as in claim 8, comprising processing electric signals relating to the induced magnetic field, and the amplitude of the magnetic field induced is estimated in a prediction time at least less than the period of said frequency of oscillation.

11. The method as in claim 10, wherein said processing comprises processing the the frequency and the phase of the oscillation motion of the casting equipment.

12. Equipment for continuously casting of steel comprising a device for detecting the level of molten steel, wherein the detecting comprises generating a continuous magnetic field oriented transversely to the direction of advance of the steel in the casting equipment, so as to generate alternate induced currents in the advancing molten steel, and detecting a variable magnetic field generated by and concatenated with said alternate induced currents, the intensity of the variable magnetic field being correlated to the level of the molten steel in the casting equipment with respect to an operating height at which magnetic field generating means and magnetic field detection means are positioned.
